(19) United States
(12) Patent Application Publication
(10) Pub. No.: US 2011/0295748 A1
(43) Pub. Date: Dec. 1, 2011

(54) DIGITAL CREDIT CARD

(76) Inventor: CHRISTOPHER WOODRIFFE, Brooklyn, NY (US)

(21) Appl. No.: 12/788,970

(22) Filed: May 27, 2010

(51) Int. Cl. G06Q 40/00; H04B 7/00; G06K 19/067

(52) U.S. Cl. 705/44; 235/492; 455/41.2

(57) ABSTRACT

A digital credit card for transactional processes and a method of using the same, where said credit card comprises: a memory for storing data; a processor, where said processor executes functions related to the credit card: an input; an output; and a biometric security, where said biometric security activates the credit card. The memory may include read only memory and random access memory. The biometric security may include fingerprint identification, iris identification or retina identification.

### BACKGROUND OF THE INVENTION

1. Field of Invention

The present invention relates to a digital credit card device capable of providing access to multiple accounts on a single device.

2. Description of Related Art

Credit and debit cards are an effective means to conduct sales transactions and almost an essential component of modern society. The credit card/debit includes a magnetic strip that stores data to execute the related transaction. Each credit card or debit card is normally associated with an individual banking account and its particular account numbers. Consequently, if an individual has multiple charge accounts and bank accounts the person is required to carry a single card for each account and may consequently end up carrying multiple cards. The design of the credit card is also used for other functions such as frequent flyer accounts, long distance accounts and medical/insurance cards.

Digital electronics have dominated the consumer market in recent years. Many devices have been developed including personal digital assistants (PDA), cellular phones, digital cameras and video recorders. As a result of this extensive development, various technologies have developed in order to make these devices more convenient and functional. Chip memory capabilities have significantly increased thus enabling adequate storage capacity for both operating and application software on many handheld and pocket size devices. It would be advantageous therefore to utilize the latest memory capabilities to develop a small device capable of storing and accessing data associated with multiple credit cards and other account information and therefore obviating the need for the consumer to carry multiple credit cards.

### SUMMARY OF THE INVENTION

The present invention relates to a digital credit card for transactional processes comprising: a memory means for storing data; a processor, where said processor executes functions related to the credit card: an input means; an output means; and a biometric security means, where said security means activates the credit card. The memory means may include read only memory and random access memory. The biometric security means may include fingerprint identification, iris identification or retina identification.

The present invention further includes a method of conducting credit transactions comprising the steps of: storing multiple credit card data on a memory chip, where said memory chip resides on a digital credit card for transactional processes where said card also includes a processor, where said processor executes functions related to the credit card: an input means; an output means; and a biometric security means, where said security means activates the credit card; electing a specific account to execute a transaction where said account is associated with data on the memory chip; activating the card using the security means; and executing a transaction using the card.

### BRIEF DESCRIPTION OF DRAWINGS

FIG. 1A depicts a digital credit card according to the present invention.

FIG. 1B depicts a rear view of the digital credit card according to the present invention.

FIG. 2A depicts an exemplary display according to the present invention.

FIG. 2B depicts another exemplary display according to the present invention.

FIG. 2C depicts another exemplary display according to the present invention.

### DETAILED DESCRIPTION

The present invention provides a digital credit card that is capable of storing multiple bank account information and may be available to use for traditional purchasing transactions. The present invention enables a person to carry a single device as opposed to multiple cards in order to conduct transactions.

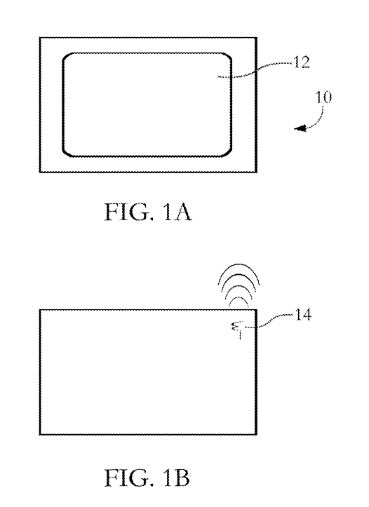

The present invention includes a digital credit card 10 as depicted in FIG. 1A. The digital credit card 10 includes an interactive touch screen 12. The present invention provides a sleek and compact device, which stores multiple credit card data on memory residing within the digital credit card 10. Each individual account's data may be stored within the digital credit card 10 and accessed for transactions by presentation of the digital credit card 10 to a retailer or merchant. The user may to elect which account should be charged for the transaction by using the interactive touch screen 12. This data may be manually input into the digital credit card 10 or electronically transferred by connecting the digital credit card 10 to a computer or wirelessly utilizing Bluetooth technology. The digital credit card 10 includes security features, such as access codes or biometric imaging, that limit access to only one individual and therefore it prohibits the ability for thieves or for any other person who may find a lost card to use the digital credit card 10.

The digital credit card 10 according to the present invention may include biometric imaging and security via the touch screen 12. The biometric security may record the fingerprint of the user and store the image of the fingerprint in memory. The digital credit card 10 therefore needs to be activated by recognition of the user's fingerprint applied to the touch screen 12. Upon recognition of the user via the touch screen 12, the digital credit card 10 may be activated for transactional purposes. Once the card is activated, the user may then use the touch screen 12 to indicate or to designate the particular account that will be used for the desired transaction.

In addition to fingerprint identification, the present invention contemplates an alternative embodiment that includes iris or retina scanning recognition access as opposed to the fingerprint recognition. The eye scanning process and recognition can similarly identify an individual by scanning the individual's eye since the characteristics of each person's eye is unique similar to a fingerprint. Either means of individual identification therefore enables the digital credit card 10 for transaction purposes. In addition, the digital credit card 10 according to the present invention includes Bluetooth technology whereas the card may electronically execute transactions via a wireless Bluetooth connection. FIG. 1B shows a rear view of the digital credit card 10 that includes a depiction of a Bluetooth wireless antenna.

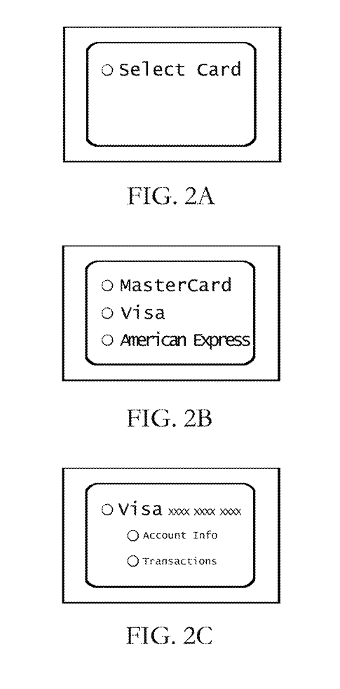

FIGS. 2A-2C show exemplary displays according to the present invention. A user may touch a select card icon as shown in FIG. 2A which may then activate a listing of credit cards as shown in FIG. 2B. The user may then select a desired credit card to execute the transaction and in response to the selection, the account data associated with the selected account may be displayed as shown in FIG. 2C. These displays provide examples of the functionality associated with the present invention, a plurality of card data may be stored on the digital card 10 and a user may scroll through a listing of cards as desired. For each account, the user may access all account information such as account balance, pending charges, payments, available credit and so on and activate the card for a transaction.

The use of the single digital credit card 10 according to present invention therefore obviates the need for multiple credit cards and provides the user with a single device for transactional use. The digital credit card 10 according to the present invention also provides a huge security mechanism by implementing biometrics and therefore providing an essentially fail safe security feature on the digital credit card 10. The digital credit card 10 according to the present invention may also include features related to account notification such as account balance, purchase history, payment dates and spending limits that may be associated with the accounts that are stored on the digital credit card. Nonetheless, if the digital credit card is lost or stolen an individual simply would not be able to use it due to the biometric security features incorporated in the present invention.

What is claimed is:

1. A digital credit card for transactional processes comprising:
a. a memory means for storing data;
b. a processor, where said processor executes functions related to the credit card:
c. an input means;
d. an output means; and
e. a biometric security means, where said security means activates the credit card.

2. The digital credit card according to claim 1, where said memory means includes read only memory and random access memory.

3. The digital credit card according to claim 1, where the biometric security means includes at least one of fingerprint identification, iris identification and retina identification.

4. The digital credit card according to claim 2, where the output means includes Bluetooth signal transmission.

5. The digital credit card according to claim 1, where said data includes a plurality of credit card data associated with a user, where said credit card data is accessible for transactions.

6. The digital credit card according to claim 5, where said credit card data in entered into the memory means via said input means.

7. A method of conducting credit transactions comprising the steps of:
a. storing multiple credit card data on a memory chip, where said memory chip resides on a digital credit card for transactional processes where said card also includes a processor, where said processor executes functions related to the credit card: an input means; an output means; and a biometric security means, where said security means activates the credit card;
b. electing a specific account to execute a transaction where said account is associated with data on the memory chip;
c. activating the card using the security means; and
d. executing a transaction using the card.

8. The method of conducting credit transactions according to claim 7, where said step of executing is conducted by using Bluetooth technology.
